(19) United States
(12) Patent Application Publication
(10) Pub. No.: US 2026/0111357 A1
(43) Pub. Date: Apr. 23, 2026

(54) STORAGE DEVICE AND STORAGE SYSTEM INCLUDING THE SAME

(71) Applicant: Samsung Electronics Co., Ltd., Suwon-si (KR)

(72) Inventors: Jeangsu Hwang, Suwon-si (KR); Yeongjae Gwon, Suwon-si (KR)

(73) Assignee: Samsung Electronics Co., Ltd., Suwon-si (KR)

(21) Appl. No.: 19/096,339

(22) Filed: Mar. 31, 2025

(30) Foreign Application Priority Data
Oct. 23, 2024 (KR) 10-2024-0145585

(51) Int. Cl. G06F 12/02

(52) U.S. Cl. CPC G06F 12/0246

(57) ABSTRACT

A storage system is provided, the storage system including: a host device including a host memory and a host storage having a storage capacity greater than a storage capacity of the host memory; and a storage device including a memory device and a storage controller, wherein the storage controller is configured to control the memory device in response to a control command received from the host device, wherein the host device is configured to exclusively allocate a portion of the host memory to the storage controller as a host memory buffer, and wherein the host device is configured to dump HMB data stored in the host memory buffer by the storage controller to the host storage.

### CROSS-REFERENCE TO RELATED APPLICATION(S)

This application claims the benefit under 35 USC 119(a) of Korean Patent Application No. 10-2024-0145585 filed on Oct. 23, 2024 in the Korean Intellectual Property Office, the entire disclosure of which is incorporated herein by reference for all purposes.

### BACKGROUND

The present inventive concept relates to a storage device and a storage system including the same.

A storage device may be combined with a host device to store data transmitted by the host device, and transmit the stored data to the host device. The storage device may include a memory device and a storage controller, and the storage controller may be connected to the host device through a predetermined interface. The storage controller may store data in a non-volatile memory device in which data is not damaged even when power supplied from the host device is cut off. The storage device may further include a random access memory device that can write and read data faster than the memory device, to improve a data transfer speed for exchanging data with the host device. However, due to limitations in a form factor of storage devices and demand to increase data storage capacity, a storage device excluding a random access memory device or minimizing the capacity thereof has been proposed.

### SUMMARY

An aspect of the present inventive concept is to provide a storage device and a storage system including the same, which can successfully collect log data necessary for recovery and analysis, even in the event of abnormal operations, by having the storage device being allocated a portion of a host memory included in a host device to a host memory buffer and exclusively using the same, and storing log data generated during an operation of the storage device in the host memory buffer.

According to an aspect of the present inventive concept, a storage system includes: a host device including a host memory; and a storage device including a memory device and a storage controller, wherein the storage controller is configured to control the memory device in response to a control command received from the host device, wherein the host device is configured to exclusively allocate a portion of the host memory to the storage controller as a host memory buffer (HMB) in response to a request from the storage controller, wherein the storage controller is configured to generate an HMB content entry including log data generated during an operation of the storage device, wherein the HMB content entry has a format that can be read by the host device, and wherein the storage controller is configured to store the HMB content entry in the host memory buffer, and wherein the storage device is configured to generate an HMB content list comprising a list of a plurality of HMB content entries including different log data, and wherein the host device is configured to read the plurality of HMB content entries from the host memory buffer using the HMB content list.

According to an aspect of the present inventive concept, a storage system includes: a host device including a host memory and a host storage having a storage capacity greater than a storage capacity of the host memory; and a storage device including a memory device and a storage controller, wherein the storage controller configured to control the memory device in response to a control command received from the host device, wherein the host device is configured to exclusively allocate a portion of the host memory to the storage controller as a host memory buffer (HMB) in response to a request from the storage controller, and wherein the host device is configured to dump HMB data stored in the host memory buffer by the storage controller to the host storage.

According to an aspect of the present inventive concept, a storage system includes: a memory device configured to store data; an interface connected to an external host device; and a storage controller configured to control the memory device in response to a command received through the interface, wherein a portion of a host memory included in the host device is allocated to the storage controller as a host memory buffer, in response to a request from the storage controller, and wherein the storage controller is configured to store log data generated during control of the memory device in the host memory buffer.

### BRIEF DESCRIPTION OF DRAWINGS

The above and other aspects, features, and advantages of the present inventive concept will be more clearly understood from the following detailed description, taken in conjunction with the accompanying drawings, in which:

FIGS. 1A and 1B are schematic diagrams illustrating a storage device according to some embodiments of the present inventive concept;

FIGS. 2 and 3 are schematic block diagrams illustrating a storage system including a storage device according to some embodiments of the present inventive concept;

FIG. 4 is a diagram provided to illustrate an operation of a storage system according to example embodiment of the present inventive concept;

FIG. 5A and FIG. 5B are diagrams provided to illustrate an operation of a storage system according to example embodiment of the present inventive concept;

FIG. 6 is a block diagram simply illustrating a storage system according to example embodiment of the present inventive concept;

FIG. 7 is a diagram provided to illustrate an operation of a storage system according to example embodiment of the present inventive concept;

FIGS. 8 and 9 are diagrams provided to illustrate an operation of a storage system according to example embodiment of the present inventive concept; and

FIGS. 10 and 11 are diagrams provided to illustrate an operation of a storage system according to some embodiments of the present inventive concept.

### DETAILED DESCRIPTION

Hereinafter, preferred example embodiments of the present inventive concept will be described with reference to the attached drawings.

Described herein are techniques for efficient memory use in storage devices that lack dynamic random access memory (DRAM) or have limited DRAM capacity. Due in part to form factor limitations and in part to increased demand for data storage capacity, storage devices that include DRAM in limited capacity or that lack DRAM altogether are employed in some embodiments. The inventors have appreciated, however, that the absence of high-capacity DRAM from storage devices poses a challenge. High-capacity DRAM-based buffers are often used to alleviate the difference in speed between the storage device and the host device. In the absence of high-capacity DRAMs, operations associated with the storage device are less efficient.

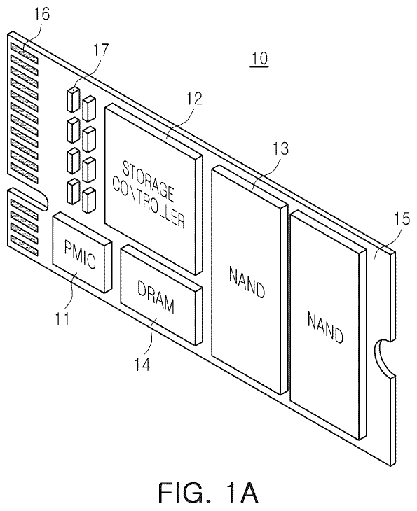

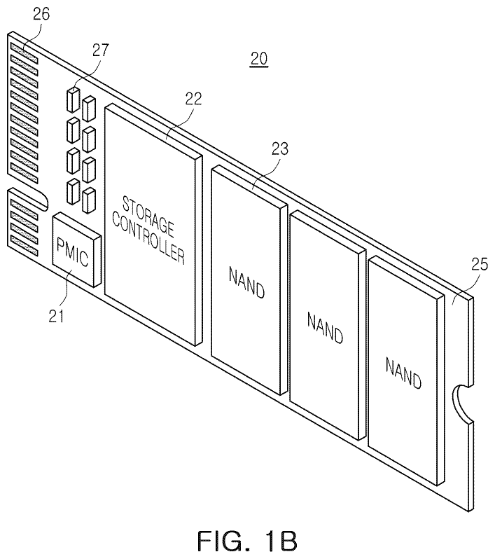

To alleviate this problem, storage devices in accordance with the present disclosure rely on a portion of the host memory. This portion of the host memory is designated for exclusive use by the storage device, and is referred to herein as host memory buffer (HMB). In some embodiments, the HBM replaces the function of DRAM-based buffers in those embodiments that lack DRAM-based buffers or complements the function low-capacity DRAM-based buffers in those embodiments that include low-capacity DRAM-based buffers. The storage device can store various types of data in the HMB, including for example crash log data, runtime log data, code overlay data, snapshot data and memory configuration data. FIGS. 1A and 1B are schematic diagrams illustrating a storage device according to some embodiments of the present inventive concept.

In the example embodiments described with reference to FIGS. 1A and 1B, each of storage devices 10 and 20 may be a solid state drive device. Referring to FIGS. 1A and 1B, each of the storage devices 10 and 20 may have a form factor according to an M.2 standard, and may communicate with an external host, such as a central processing unit, a system-on-chip, an application processor, or the like, according to a PCI-Express protocol.

Each of the storage devices 10 may include power circuits 11 and 21, storage controllers 12 and 22, memory devices 13 and 23, system boards 15 and 25, and the like. The power circuits 11 and 21, the storage controllers 12 and 22, and the memory devices 13 and 23 may be connected to each other by wiring patterns formed on the system boards 15 and 25.

The system boards 15 and 25 may include connectors 16 and 26 including a plurality of pins for connection to a host device. The number and disposition of the plurality of pins included in the connectors 16 and 26 may vary depending on a communication interface between the storage devices 10 and 20 and the host device. In example embodiments, the storage devices 10 and 20 may communicate with an external host according to any one of the following interfaces: Universal Serial Bus (USB), Peripheral Component Interconnect Express (PCI-Express), Serial Advanced Technology Attachment (SATA), M-Phy for Universal Flash Storage (UFS), or the like. For example, the storage devices 10 and 20 according to some embodiments illustrated in FIGS. 1A and 1B may communicate with a host device according to the PCI-Express protocol.

The storage devices 10 and 20 may be operated by power supplied from a host device through connectors 16 and 26. Power circuits 11 and 21 of the storage devices 10 and 20 may be Power Management Integrated Circuits (PMIC (Powers) generating internal voltage necessary for the operation of the storage controllers 12 and 22 and memory devices 13 and 23 by using an external voltage supplied by the host device through connectors 16 and 26.

The storage controllers 12 and 22 may write data to or read data from the memory devices 13 and 23, in response to a command received from the host device. For example, the storage devices 10 and 20 may include a plurality of memory devices 13 and 23 mounted on the system boards 15 and 25, and each of the plurality of memory devices 13 and 23 may include two or more memory chips. The memory chips may be NAND memory chips.

The storage device 10 according to the example embodiment illustrated in FIG. 1A, unlike the storage device 20 according to the example embodiment illustrated in FIG. 1B, may include a Dynamic Random Access Memory (DRAM) 14. The DRAM 14 may be a buffer memory for alleviating a speed difference between the memory devices 13 in which data is stored and the host device. The DRAM 14 included in the storage device 10 may also function as a kind of cache memory, and may also provide space for temporarily storing data in a control operation for the memory devices 13. In the example embodiment illustrated in FIG. 1A, the storage controller 12 may further include a DRAM controller for controlling the DRAM 14 in addition to the NAND controller for controlling the memory devices 13.

As illustrated in FIGS. 1A and 1B, in order to increase the capacity of the storage devices 10 and 20, it may be advantageous to increase the number of memory devices 13 and 23 mounted on the system boards 15 and 25, but there may be a limitation in the number of memory devices 13 and 23 that can be mounted on the system boards 15 and 25 in a predetermined form factor. Therefore, as illustrated in FIG. 1B, implementing the storage device 20 with a structure removing a DRAM may be advantageous from the perspective of increasing the storage space.

However, as described above, the DRAM 14 may operate as a buffer which buffers a speed difference between the memory devices 13 in which data is stored and the host device 13. In addition, in some embodiments, a logical-physical (L2P) mapping table may be stored in the DRAM 14 while the storage device 10 is operating. Therefore, the performance of the storage device 20 having a structure from which the DRAM is removed may be lower than the performance of the storage device 10 having a structure including the DRAM 14.

In some embodiments of the present inventive concept, a storage device 20, not including a DRAM may be exclusively allocated portion of the host memory included in the host device and utilize the same. In addition, depending on the embodiment, a low-capacity DRAM 14 may be included in the storage device 10, and the storage device 10 may be exclusively allocated a portion of the host memory and utilize the same. The portion of the host memory that is exclusively allocated to the storage devices 10 and 20 may be defined as host memory buffers.

When a host memory buffer is allocated, the storage controllers 12 and 22 may utilize the host memory buffer in a similar manner to the DRAM 14 provided in the storage devices 10 and 20. For example, the storage controllers 12 and 22 may load a logical-physical mapping table into the host memory buffer and utilize the same.

In some embodiments of the present inventive concept, the storage controllers 12 and 22 may store log data generated while the storage devices 10 and 20 are operating, in the host buffer. Therefore, even if an abnormal operation occurs in the storage devices 10 and 20, the log data stored in the host memory buffer physically included in the host device may not be lost. In some embodiments, when the abnormal operation of the storage device 10 and 20 is detected, the host device can store log data stored in the host memory buffer in a host storage, separate from the storage device 10 and 20 and preserve the same.

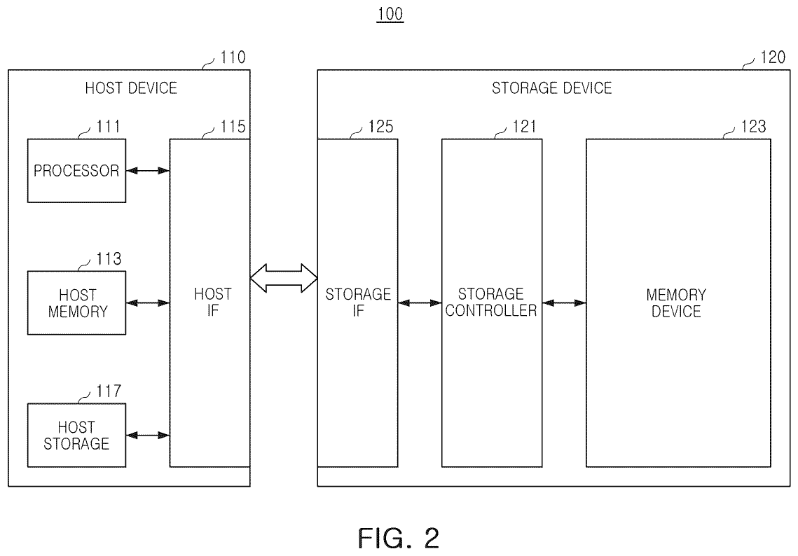

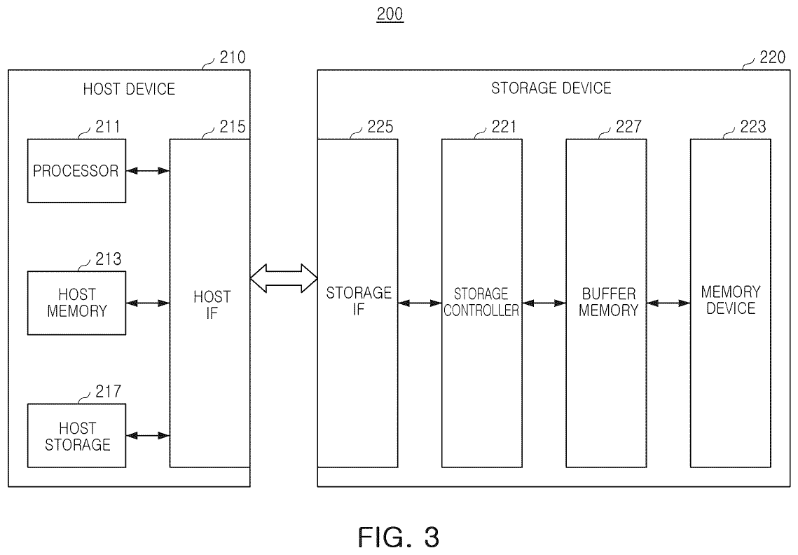

FIGS. 2 and 3 are block diagrams simply illustrating a storage system including a storage device according to some embodiments of the present inventive concept.

First, referring to FIG. 2, a storage system 100 according to some embodiments of the present inventive concept may include a host device 110, a storage device 120, and the like. The host device 110 may include a processor 111, a host memory 113, a host interface 115, a host storage 117, and the like. The storage device 120 may include a storage controller 121, a memory device 123, a storage interface 125, and the like.

The host device 110 is a device supplying power to the storage device 120 and controlling the operation of the storage device 120, and may be a device such as a desktop computer, a laptop computer, a server, a smartphone, a tablet PC, or the like. The host device 110 and the storage device 120 are connected through a predetermined interface, and for example, the host device 110 and the storage device 120 may be connected to each other through an interface such as USB, PCI-Express, SATA, or M-Phy for UFS. The host device 110 may include a host interface 105 supporting the interface, and the storage device 120 may include a storage interface 125 supporting the interface.

The processor 111 of the host device 110 may control an overall operation of the storage system 100. For example, the processor 111 may be implemented as a general-purpose processor, a dedicated processor, an application processor, or the like. The processor 111 may include one or more cores, and may further include a separate controller for controlling the host memory 113, the host storage 117, the storage device 120, or the like. Depending on the embodiment, the processor 111 may also include an accelerator, which is a dedicated circuit for high-speed data operations such as artificial intelligence (AI) data operations.

The host memory 113 may be used as a main memory device of the storage system 100 and may include volatile memory such as Static Random Access Memory (SRAM) and/or DRAM. However, depending on the embodiment, the host memory 113 may include non-volatile memory such as flash memory, Phase change Random Access Memory (PRAM), Resistive Random Access Memory (RRAM), or the like. In some embodiments, the host memory 113 may be implemented in a single package with the processor 111.

The host storage 117 is a device including a non-volatile memory, and may provide a relatively large storage capacity as compared to that of the host memory 113. The host storage 117 may be implemented as a solid state drive (SSD), a hard disk drive (HDD), or the like. The host memory 113 and the host storage 117 may be connected to a processor 111 through the host interface 115, and may operate in response to commands from the processor 111.

The storage device 120 is implemented as a structure which is separable from the host device 110, and may be a device to which a standard specification such as Universal Flash Storage (UFS), embedded multi-media card (eMMC), or non-volatile memory express (NVMe) is applied. The storage device 120 may include a memory device 123 implemented as a non-volatile memory. The storage controller 121 may store data received from the host device 110 through the storage interface 125 in the memory device 123, and read the data stored in the memory device 123 and transmit the same to the host device 110 through the storage interface 125.

Next, referring to FIG. 3, a storage system 200 according to some embodiments of the present inventive concept may include a host device 210, a storage device 220, and the like. The host device 210 may include a processor 211, a host memory 213, a host interface 215, a host storage 217, and the like. The storage device 220 may include a storage controller 221, a memory device 223, a storage interface 225, a buffer memory 227, and the like.

In the storage system 200 according to some embodiments illustrated in FIG. 3, the remaining configuration thereof except for a buffer memory 227 may be similar to the storage system 100 according to some embodiments described with reference to FIG. 2. The buffer memory 227 may be connected between the storage controller 221 and the memory device 223, and may be implemented as a memory having a faster operating speed than the memory device 223, such as DRAM, PRAM, RRAM, or the like. By connecting the buffer memory 227 between the storage controller 221 and the memory device 223, data transfer speed degradation which occurs between the storage controller 221 and the memory device 223 may be alleviated. Alternatively, the performance of the storage device 220 may be improved by loading the data required for the storage controller 221 to control the memory device 223 into the buffer memory 227.

However, due to the limitations of the storage device 220 with severe space constraints, when a buffer memory 227 of sufficient capacity required by the storage controller 221 is included in the storage device 220, the capacity of the memory device 223 may not be sufficiently secured. Conversely, if the storage device 120 is implemented with the structure as shown in FIG. 2 without a buffer memory 227, the capacity of the memory device 123 may be sufficiently secured, but the performance of the storage device 120 may be degraded.

In some embodiments of the present inventive concept, storage controllers 121 and 221 may be allocated from host devices 110 and 210 to exclusively use a portion of host memories 113 and 213. Accordingly, it is possible to secure sufficient capacity of the memory devices 123 and 223 while minimizing the performance degradation of the storage device 120 and 220. A portion of the host memories 113 and 213, allocated for exclusive use by the storage controllers 121 and 221, may be defined as a host memory buffer.

Depending on the embodiment, various data may be stored in a host memory buffer. The storage controllers 121 and 221 may store a logical-physical mapping table in the host memory buffer. In addition, in some embodiments, the storage controllers 121 and 221 may store log data generated during the operation of the storage devices 120 and 220 in the host memory buffer. The log data may include crash log data, runtime log data, code overlay data, snapshot data, configuration info data, and the like.

Even if an abnormal situation occurs, such as an abnormal operation in storage devices 120 and 220 or the storage devices 120 and 220 being unexpectedly separated from the host devices 110 and 210, the log data stored in the host memory buffer can be maintained as it is. In some embodiments of the present inventive concept, the host devices 110 and 210 may dump log data stored in the host memory buffer when an abnormal situation occurs in the storage devices 120 and 220, and for example, may store log data in host storages 117 and 217.

The log data stored in the host storages 117 and 217 may be provided to the storage controllers 121 and 221 after the abnormal situation that has occurred in the storage devices 110 and 210 is terminated. The storage controllers 121 and 221 may analyze the log data to analyze the type and cause of the abnormal situation that has occurred previously or perform a debugging operation, and can also provide the same to the user of the storage systems 100 and 200. However, the data stored in the host memory buffer is not necessarily limited to log data. Depending on the embodiment, the storage controllers 121 and 221 may store data related to the operation and control of the storage devices 120 and 220, other than log data, in the host memory buffer. The host devices 110 and 210 may prevent the loss of data stored in the host memory buffer by executing a dump operation which stores data stored in the host memory buffer to the host storages 117 and 217, or the like.

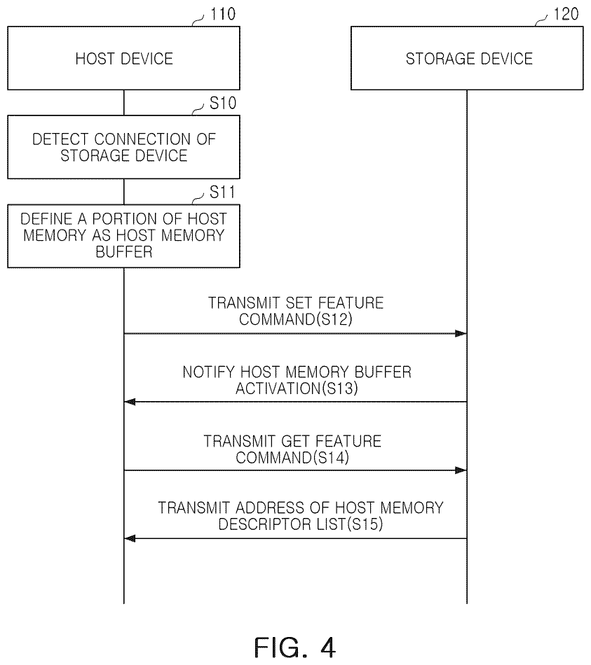

FIG. 4 is a diagram provided to illustrate an operation of a storage system according to some embodiments of the present inventive concept.

Referring to FIG. 4, the operation of the storage system according to some embodiments of the present inventive concept may begin with the host device 110 detecting the connection of the storage device 120 (S10). As described above, the storage device 120 may be connected to the host device 110 through an interface such as SATA, PCI-Express, USB, or M-Phy for UFS.

When the connection of the storage device 120 is detected, the host device 110 may define a portion of the host memory as a host memory buffer (S11). The host device 110 may allocate a portion of the host memory as the host memory buffer, in response to a request from a storage controller included in the storage device 120. The host device 110 may load and run the operating system into the host memory and define a portion of the remaining available memory region as a host memory buffer.

The host memory buffer is a region exclusively allocated to the storage device 120, and the host device 110 has limited access to only a portion of the host memory allocated to a host memory buffer. For example, a program operation in which the host device 110 writes data may be prohibited for a portion of the host memory allocated to the host memory buffer.

The host device 110 may generate a Set Feature Command to enable the host memory buffer and transmit the Set Feature Command to the storage device (S12). In the process of defining the host memory buffer, the host device 110 may determine an address, capacity, properties, and the like, of a portion of the host memory defining the host memory buffer. The host device 110 may generate a host memory descriptor list including the address, capacity, properties, and the like of a region allocated to a host memory buffer among the host memories. The host memory descriptor list may be stored in the host memory, and the address information of the region in which the host memory descriptor list is stored in the host memory may be provided to the storage device 120 together with the Set Feature Command.

The storage device 120 may obtain a host memory descriptor list from the host memory by referring to the address information received in step S12, and may notify the host device 110 of an enablement of the host memory buffer (S13). The host device 110 that has confirmed the enablement of the host memory buffer may transmit a Get Feature Command to the storage device 120 (S14). The storage device 120 may transmit address information of a host memory descriptor list acquired from the host memory to the host device 110 in response to the Get Feature Command (S15). Through the above-described process, a portion of the host memory may be utilized as an exclusive space of the storage device 120 as a host memory buffer.

The storage controller of the storage device 120 may refer to a host memory descriptor list stored in the host memory based on an address received together with a Set Feature Command, and may access a portion of the host memory allocated to a host memory buffer by referring to the host memory descriptor list. For example, the storage controller may store a logical-physical mapping table in a region of the host memory allocated to the host memory buffer, or store various log data generated during operation of the storage device 120 in the region of the host memory allocated to the host memory buffer.

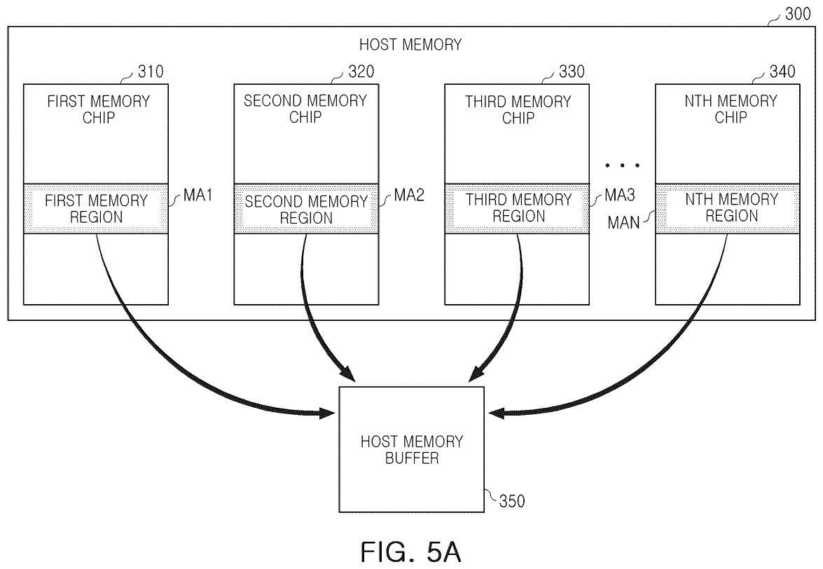

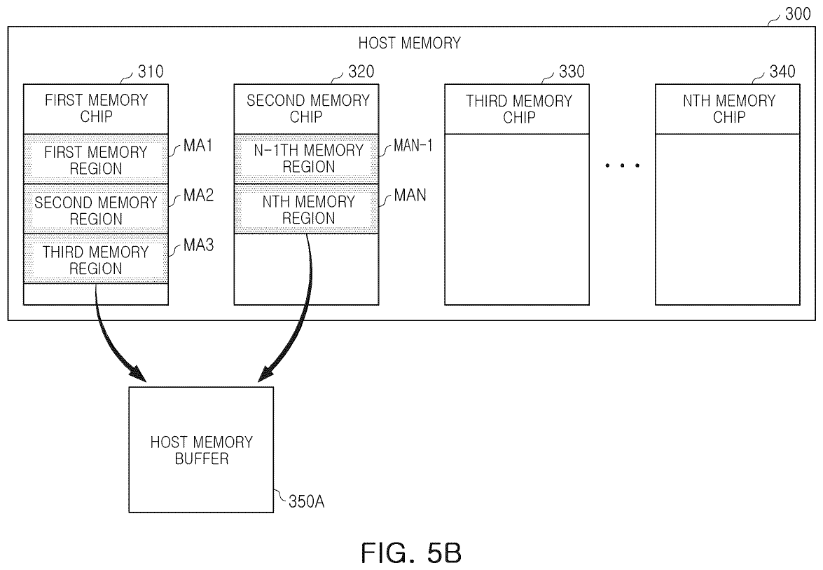

FIGS. 5A and 5B are diagrams provided to illustrate an operation of a storage system according to some embodiments of the present inventive concept.

FIGS. 5A and 5B may be diagrams provided to illustrate a method of allocating a portion of a host memory to a host memory buffer. Referring to FIGS. 5A and 5B, a host memory 300 may include a plurality of memory chips 310 to 340. The plurality of memory chips 310 to 340 may be included in one memory module or in different memory modules, and the memory module may have a structure such as a Dual In-line Memory Module (DIMM), a Small Outline Dual In-line Memory Module (SODIMM), or the like.

First, referring to FIG. 5A, a host memory buffer 350 may be generated with memory regions (MA1 to MAN), selected from each of the plurality of memory chips 310 to 340. In some embodiments illustrated in FIG. 5A, a portion of storage space provided by each of the plurality of memory chips 310 to 340 included in the host memory 300 may be allocated to the memory regions (MA1 to MAN), and a host memory buffer 350 may be configured with the memory regions (MA1 to MAN).

In some embodiments illustrated in FIG. 5B, at least one of the plurality of memory chips 310 to 340 may not provide a memory region, necessary to configure a host memory buffer 350A. Referring to FIG. 5B, the first memory chip 310 and the second memory chip 320 may provide memory regions (MA1 to MAN) included in the host memory buffer 350A. Depending on the embodiment, the host memory buffer (350, 350A) may be configured with only a region provided by one of the plurality of memory chips 310 to 340.

The configuration of the host memory buffer (350, 350A) may be changed during operations of a host device and a storage device. In some embodiments, when the storage device transitions from a normal mode to a standby mode, a power-saving mode, or the like, which consumes relatively little power, the host memory buffer (350, 350A) may be deallocated. Thereafter, when the storage device starts operating again, the host device may select memory regions (MA1-MAN) from the plurality of memory chips 310 to 340 and re-allocate the host memory buffer (350, 350A) to the storage device.

According to some embodiments, the host device may maintain data stored in the host memory buffer (350, 350A) in the host memory 300 without deleting the data under the condition that the storage device enters a standby mode, a power saving mode, or the like, so that the configuration of the host memory buffer (350, 350A) is released. Alternatively, under the condition that the configuration of the host memory buffer (350, 350A) is released, the host device can store data stored in the host memory buffer (350, 350A) in a host storage, which is a separate storage space, which is different from the storage device. The host device may transmit data stored in the host storage to the storage device when the host memory buffer (350, 350A) is reconfigured, and the storage device may store data received from the host device back into the host memory buffer (350, 350A).

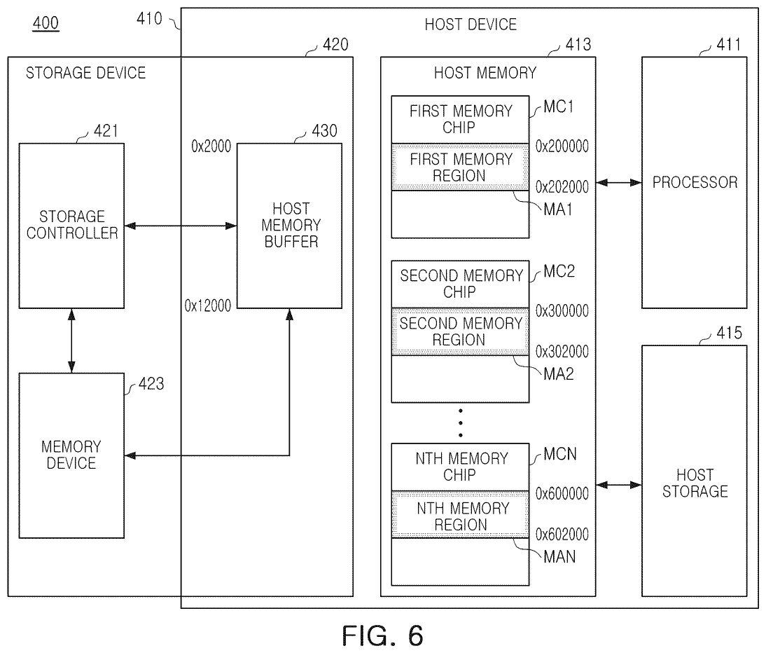

FIG. 6 is a block diagram simply illustrating a storage system according to some embodiments of the present inventive concept.

Referring to FIG. 6, a storage system 400 according to some embodiments of the present inventive concept may include a host device 410 and storage device 420. The host device 410 may include a processor 411, a host memory 413, a host storage 415, and the like, and the storage device 420 may include a storage controller 431, a memory device 423, and the like. The host storage 415 and the memory device 423 may be implemented as a non-volatile memory such as a flash memory.

The host memory 413 is a memory having a relatively fast operation speed compared to the host storage 415 and the memory device 423, and may be implemented as DRAM, PRAM, RRAM, SRAM, or the like. The host memory 413 may include a plurality of memory chips (MC1 to MCN). In some embodiments of the present inventive concept, when a storage device 420 is connected to a host device 410, a portion of memory regions (MA1 to MAN) of the storage space provided by the host memory 413 may be allocated to a host memory buffer 430.

The host memory buffer 430 may be a region to which the host device 410 has limited access and may be a region exclusively used by the storage controller 421. For example, the processor 411 may read data stored in the memory regions (MA1 to MAN) allocated to the host memory buffer 430, but deletion of data stored in the memory regions (MA1 to MAN) allocated to the host memory buffer 430, and programs of data for the memory regions (MA1 to MAN) allocated to the host memory buffer 430 may not be permitted to the processor 411.

In some embodiments illustrated in FIG. 6, the host device 410 may select memory regions (MA1 to MAN) from each of a plurality of memory chips (MC1 to MCN) included in the host memory 413 and define a host memory buffer 430 with the memory areas (MA1 to MAN). Addresses of the memory regions (MA1 to MAN) selected by the processor 411 from each of the plurality of memory chips (MC1 to MCN) may be defined as consecutive addresses in the host memory buffer 430. Therefore, an address referenced by the processor 411 to access the memory regions (MA1 to MAN) may be different from an address referenced by the storage controller 421 to access the host memory buffer 430.

To enable the storage controller 421 to occupy and use memory regions (MA1 to MAN) of accurate addresses as host memory buffers 430, a host memory descriptor list including the address and capacity of each of the memory regions (MA1 to MAN) may be stored in the host memory buffer 430. In some embodiments, the host memory descriptor list may include host memory descriptor entries corresponding to the memory regions (MA1 to MAN). In some embodiments illustrated in FIG. 6, a first host memory descriptor entry in which an address and capacity of the first memory region MA1 are recorded may be generated, a second host memory descriptor entry in which an address and capacity of the second memory region MA2 are recorded may be generated, and an Nth host memory descriptor entry in which an address and capacity of the Nth memory region MAN are recorded may be generated. A host memory descriptor list including the first to Nth host memory descriptor entries may be stored in a host memory buffer 430, and a storage controller 421 may utilize memory regions (MA1 to MAN) constituting the host memory buffer 430 by referring to the host memory descriptor list.

The storage controller 421 may store HMB data, such as data required to efficiently operate the storage device 420 and log data generated during the operation of the storage device 420, in the host memory buffer 430. For example, the storage controller 421 may generate HMB content entry including log data, and store the HMB content entry in a host memory buffer 430.

As described above, the processor 411 may not execute a delete operation and a program operation for the memory regions (MA1 to MAN) allocated to the host memory buffer 430, but may execute a read operation for reading data stored in the memory regions (MA1 to MAN) allocated to the host memory buffer 430. The storage controller 421 may generate HMB content lists including HMB contents entries in which log data is recorded and store the lists in the host memory buffer 430. The processor 411 may execute a read operation to read HMB content entries by referencing the HMB content lists, and obtain log data recording the operation of the storage device 420. If necessary, the processor 411 may store log data in a host storage 415, to prevent the loss of log data.

Depending on the embodiment, the HMB content list may be transferred to the host 410 during the enable process in which the host memory buffer 430 is defined and allocated to the storage device 420. The processor 410 may store the HMB content list received from the storage device 420 in another storage space of the host memory 413 which is not allocated to the host memory buffer 430, or in the host storage 415.

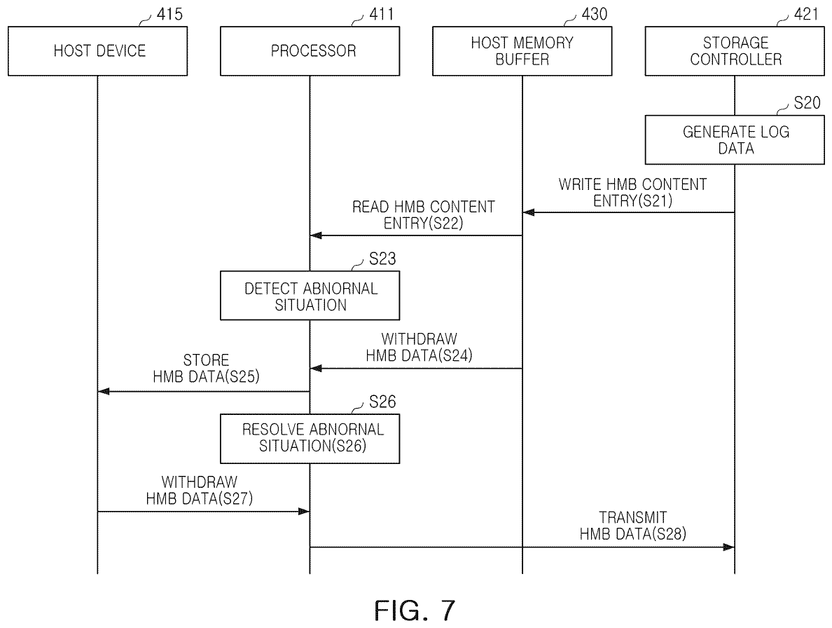

FIG. 7 is a diagram provided to illustrate an operation of a storage system according to some embodiments of the present inventive concept.

Hereinafter, an operation of a storage system 400 will be described with reference to FIGS. 6 and 7 together. When the connection of the storage device 420 is detected, the host device 410 may select memory regions (MA1 to MAN) to define a host memory buffer 430 and allocate the host memory buffer 430 as a region that can be exclusively used by the storage controller 421. The operation of configuring the host memory buffer 430 and allocating the same to the storage controller 421 may be understood with reference to the example embodiment illustrated in FIG. 4 above.

While the host memory buffer 430 is configured and the storage device 420 is operating, the storage controller 421 may generate log data (S20). The log data may include crash log data, runtime log data, code overlay data, snapshot data, configuration information data, and the like.

The storage controller 421 may write an HMB content entry including log data to the host memory buffer 430. The HMB content entry may be configured to include address information, capacity information, log data, encrypted data, and the like, in which the HMB content entry is recorded. Encrypted data is data that describes a method of encrypting log data. For example, log data may be encrypted using an asymmetric algorithm such as Rivest Shamir Adleman (RSA), Elliptic Curve Digital Signature Algorithm (ECDSA), or the like, and recorded in the host memory buffer 430.

The processor 411 may execute a read operation to read HMB content entries by accessing memory regions (MA1 to MAN) allocated to the host memory buffer 430 (S22). However, the processor 411 may not be permitted to access the memory regions (MA1 to MAN) to execute a delete operation and a program operation. To execute the read operation of step S22, the processor 411 may refer to an HMB content list in which HMB content entries are recorded. The HMB content list may be stored in a host memory buffer 430 or in a storage space of the host device 410. Depending on the embodiment, the processor 411 may store the HMB content entries in a storage space not allocated to the host memory buffer 430 in the host memory 413 or in the host storage 415.

When an abnormal situation of the storage device 420 is detected based on the HMB content entry read in step S22, the processor 411 may obtain HMB data stored in the host memory buffer 430 (S24), and execute a dump operation to store the obtained HMB data in the host storage 415 (S25). The host storage 415 is a non-volatile memory device implemented separately from the storage device 420, and loss of HMB data may be prevented by dumping HMB data to the host storage 415.

Thereafter, if it is determined that the storage device 420 is operating normally again and the abnormal situation has been resolved (S26), the processor 411 may withdraw HMB data stored in the host storage 415 (S27), and transmit the withdrawn HMB data to the storage controller 421 (S28). In some embodiments, the storage controller 421 may control the storage device 420 by loading data, such as a logical-physical mapping table included in the HMB data, back into the host memory buffer 430. In some embodiments, the storage controller 421 may analyze an abnormal situation occurring in the storage device 420 by referencing HMB content entries included in the HMB data, and provide analysis results to the user or execute a recovery operation based on the analysis results. In addition, the storage controller 421 may also execute debugging operations using HMB content entries.

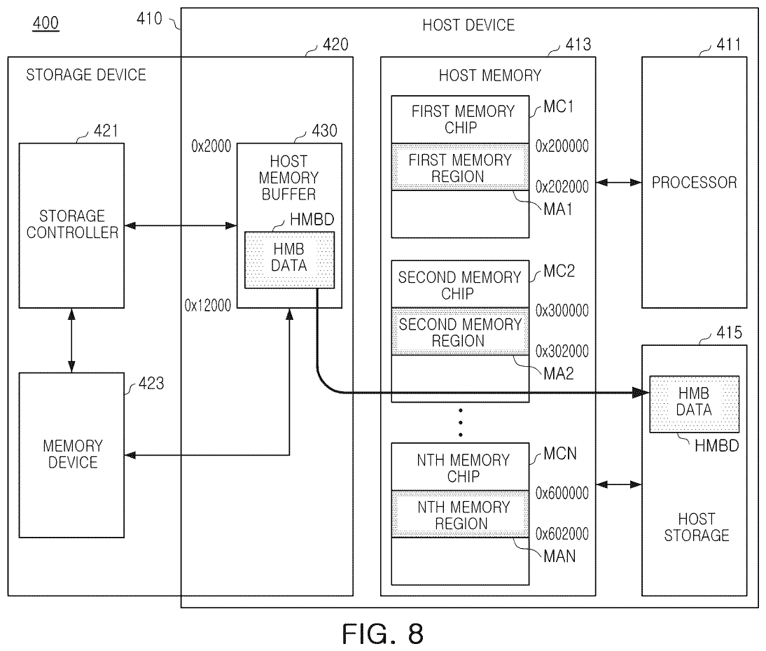

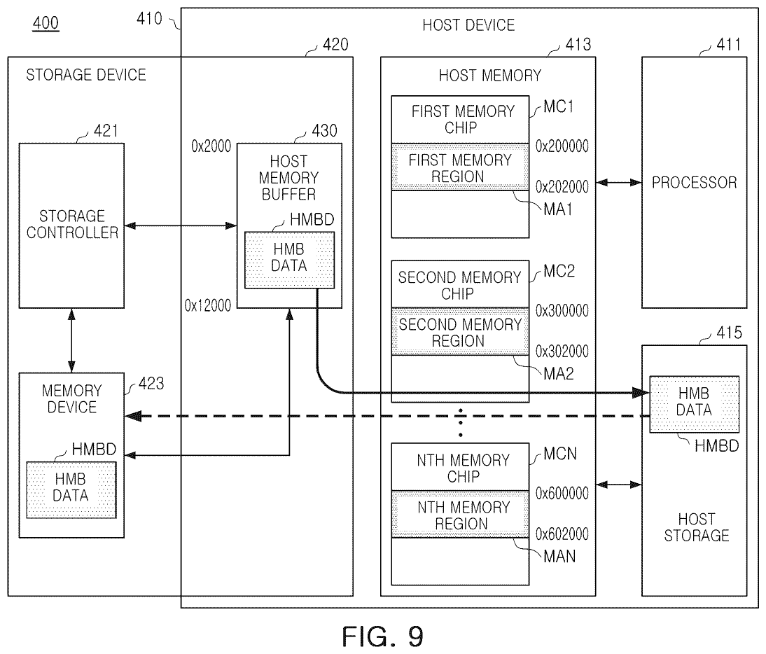

FIGS. 8 and 9 are diagrams provided to illustrate an operation of a storage system according to some embodiments of the present inventive concept.

Referring to FIGS. 8 and 9, a storage system 400 may include a host device 410 and a storage device 420, and the host device 410 detecting a connection of the storage device 420 may allocate memory regions (MA1 to MAN), a portion of the host memory 413 to a host memory buffer 430. A storage controller 421 may exclusively occupy and use the host memory buffer 430 and store HMB data (HMBD) in the host memory buffer 430.

In order for the storage controller 421 to exclusively occupy and use the host memory buffer 430, access of the processor 411 to the memory regions (MA1 to MAN) may not be fundamentally prohibited. For example, the processor 411 may not be granted the authority to write data to the memory regions (MA1 to MAN) or to delete data recorded in the memory regions (MA1 to MAN), whereas the processor 411 may have the authority to read data written to the memory regions (MA1 to MAN).

Accordingly, as illustrated in FIG. 8, the processor 411 may read HMB data (HMBD) stored in the host memory buffer 430 and store the data as a memory dump file in a host storage 415. The host storage 415 may provide a separate storage space, separated from the storage device 420, so that even if an abnormal situation occurs in the storage device 420, HMB data (HMBD) may be safely preserved in the host storage 415 without loss.

Depending on the embodiments, when the storage capacity of the memory regions (MA1 to MAN) allocated to the host memory buffer 430 is large, executing a memory dump operation on the entire host memory buffer 430 may place excessive load on the storage system 400. Accordingly, the processor 411 may execute a memory dump operation only for the HMB data (HMBD) written to the host memory buffer 430, not the entire host memory buffer 430.

When the abnormal situation of the storage device 420 is resolved, as illustrated in FIG. 9, the processor 411 may transfer the HMB data (HMBD) stored as a memory dump file in the host storage 415 to the storage device 420. The HMB data (HMBD) may be stored in the memory device 423 of the storage device 420. The storage controller 421 may analyze the cause of the abnormal situation using HMB data (HMBD) stored in the memory device 423, and provide the analysis results to an administrator, user, or the like, of the storage system 400 or execute a recovery operation based on the analysis results. The recovery operation may include a repair operation, or the like.

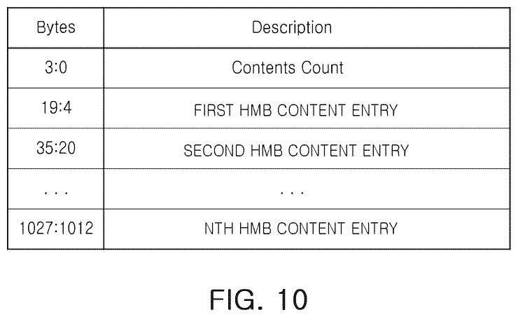

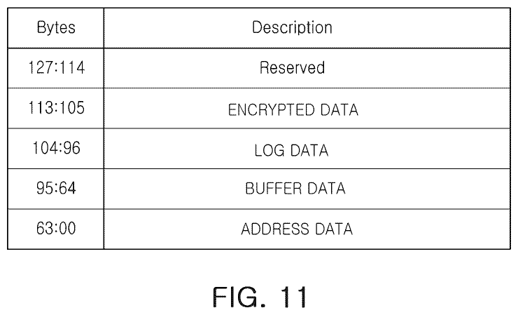

FIGS. 10 and 11 are diagrams provided to illustrate an operation of a storage system according to some embodiments of the present inventive concept.

FIGS. 10 and 11 may be diagrams for illustrating exemplary HMB data that can be generated by a storage controller and stored in a host memory buffer during an operation of a storage device. The storage controller may record log data generated during the operation of the storage device as HMB data in a host memory buffer. FIGS. 10 and 11 may be diagrams simply illustrating an HMB content entry in which log data is recorded as one type of HMB data, and an HMB content list which is a list of HMB content entries.

FIG. 10 may be a diagram illustrating an HMB content list according to some embodiments. In some embodiments illustrated in FIG. 10, the number of HMB content entries may be recorded in the first 4 bytes of storage space of the content list, and HMB content entries may be recorded one by one in each 16 bytes of storage space thereafter. However, the capacity of the storage space for recording the number of HMB content entries and the capacity of the storage space in which each of the HMB content entries is recorded may vary depending on the embodiment.

FIG. 11 may be a diagram illustrating a HMB content generated by a storage controller in some embodiments of the present inventive concept. According to the example embodiment described above with reference to FIG. 10, one HMB content entry may include 128 bits of data. Referring to FIG. 11, one HMB content entry may include address data, buffer data, log data, encrypted data, a spare region, and the like. The capacity of each item included in the HMB content entry may vary depending on the embodiment.

Address data may include address information in which the HMB content entry is recorded, and the buffer data may indicate a size of a space in which the HMB content entry is recorded. For example, the address information included in the address data may be address information that a storage controller, not a processor of a host device, references to access a host memory buffer. Log data is data generated during the operation of a storage device, and as described above, may include crash log data, runtime log data, code overlay data, snapshot data, configuration information data, and the like. Encrypted data may be data that records the encryption method of log data.

A HMB content entry may be stored in a host memory buffer in a format that can be read by a processor included in the host device. The processor may read HMB content entries and store the same in a host storage. The processor may also determine an operational status of the storage device by referencing encrypted data to decrypt log data and provide the same to the user and/or administrator of the storage system. In some embodiments, the storage controller may store log data in a host memory buffer in a format that can be output by a device such as a display device, or the like. The processor may output the decrypted log data to a display device or the like connected to the storage system, thereby providing the data to a user and/or administrator of the storage system.

As set forth above, according to some embodiments of the present inventive concept, a portion of a host memory included in a host device may be allocated to a host memory buffer that can be exclusively used by a storage device connected to the host device. The storage device may improve a data transfer speed for exchanging data with the host device by utilizing the host memory buffer, and may write log data generated during the operation of the storage device to the host memory buffer. Therefore, even during malfunctions of the storage device, the log data may not be lost and may be preserved in the host memory buffer, and by utilizing the log data for recovery, analysis, and debugging of the storage device, the reliability and performance of the storage device may be improved.

The various and beneficial advantages and effects of the present inventive concept are not limited to the above-described content, and may be more easily understood through description of specific embodiments of the present inventive concept.

While example embodiments have been illustrated and described above, it will be apparent to those skilled in the art that modifications and variations could be made without departing from the scope of the present inventive concept as defined by the appended claims.

What is claimed is:

1. A storage system, comprising:
a host device including a host memory; and
a storage device including a memory device and a storage controller, wherein the storage controller is configured to control the memory device in response to a control command received from the host device,
wherein the host device is configured to exclusively allocate a portion of the host memory to the storage controller as a host memory buffer (HMB), in response to a request from the storage controller,
wherein the storage controller is configured to generate an HMB content entry including log data generated during an operation of the storage device, wherein the HMB content entry has a format that can be read by the host device, and wherein the storage controller is configured to store the HMB content entry in the host memory buffer, and
wherein the storage device is configured to generate an HMB content list comprising a list of a plurality of HMB content entries including different log data, and wherein the host device is configured to read the plurality of HMB content entries from the host memory buffer using the HMB content list.

2. The storage system of claim 1, wherein the host device is configured to prohibit program operations on the portion of the host memory, while the portion of the host memory is allocated as the host memory buffer.

3. The storage system of claim 1, wherein the storage controller is configured to store the HMB content list in the host memory buffer.

4. The storage system of claim 1, wherein the storage controller is configured to transmit the HMB content list to the host device, and the host device is configured to store the HMB content list in a storage space other than the host memory buffer.

5. The storage system of claim 1, wherein the HMB content list includes an entry indicative of a number of the plurality of HMB content entries in the host memory buffer.

6. The storage system of claim 1, wherein the HMB content entry includes address data including address information of the host memory buffer in which the HMB content entry is stored, buffer data including a size of a space in which the HMB content entry is recorded, the log data, and encrypted data in which an encryption method of the log data is recorded.

7. The storage system of claim 6, wherein the host device is configured to search for the HMB content entry in the host memory buffer using the address data, and is configured to decrypt the log data using the encrypted data.

8. The storage system of claim 1, wherein the storage controller is configured to store the log data in the host memory buffer in a format that the host device can output to a display device.

9. The storage system of claim 1, wherein the host device is configured to read the log data stored in the host memory buffer and to store the log data as a memory dump file in a host storage, separate from the storage device.

10. The storage system of claim 9, wherein the host device is configured to transmit the memory dump file stored in the host storage to the storage controller.

11. A storage system, comprising:
a host device including a host memory and a host storage having a storage capacity greater than a storage capacity of the host memory; and
a storage device including a memory device and a storage controller, wherein the storage controller is configured to control the memory device in response to a control command received from the host device,
wherein the host device is configured to exclusively allocate a portion of the host memory to the storage controller as a host memory buffer (HMB), in response to a request from the storage controller, and
wherein the host device is configured dump HMB data stored in the host memory buffer by the storage controller to the host storage.

12. The storage system of claim 11, wherein the storage device does not include a buffer memory.

13. The storage system of claim 11, wherein the HMB data that the host device is configured to dump to the host storage includes at least one of crash log data, runtime log data, code overlay data, and snapshot data.

14. The storage system of claim 11, wherein the storage controller is configured to store a logical-physical mapping table in the host memory buffer when the host memory buffer is allocated.

15. The storage system of claim 11, wherein the host device further includes a display device, and
wherein the storage controller is configured to generate the HMB data in a format that can be read by the host device and can be output to the display device and is further configured to store the HMB data in the host storage.

16. The storage system of claim 11, wherein, when the storage device enters a first operation mode, the host device is configured to deallocate the host memory buffer, and when the storage device switches from the first operation mode to a second operation mode, the host device is configured to reallocate the host memory buffer,
wherein the first operation mode is a standby mode in which the storage device consumes less power than in the second operation mode.

17. The storage system of claim 16, wherein, when the storage device enters the first operation mode and the host memory buffer is deallocated, the host device is configured to store the HMB data in the host storage.

18. The storage system of claim 17, wherein, when the storage device switches from the first operation mode to the second operation mode, the host device is configured to transmit the HMB data stored in the host storage to the storage controller.

19. The storage system of claim 11, wherein the host device is configured to dump only a portion of the HMB data to the host storage.

20. A storage device, comprising:
a memory device configured to store data;
an interface connected to an external host device; and
a storage controller configured to control the memory device in response to a command received through the interface,
wherein a portion of a host memory included in the host device is allocated to the storage controller as a host memory buffer, in response to a request from the storage controller, and wherein the storage controller is configured to store log data generated during control of the memory device in the host memory buffer.
